(19) United States
(12) Patent Application Publication
(10) Pub. No.: US 2006/0007175 A1
(43) Pub. Date: Jan. 12, 2006

(54) Touch control method of single tap and control module thereof

(76) Inventor: Chung-Yi Shen, Taipei (TW)

Correspondence Address: G' LINK COMPANY;PmB 174, Suite 137, 931 West 75th Street, Naperville, IL, 60565, US

(21) Appl. No.: 10/883,681

(22) Filed: Jul. 6, 2004

(51) Int. Cl. G09G 5/00

(52) U.S. Cl. 345/173

(57) ABSTRACT

A touch control method of single tap, which identifies a touch of an object on a touch device by way of a control module of the touch device and a control signal being generated corresponding to the touch for being used by a main unit to perform subsequent control functions with reference time being set up in the control module, includes detecting a touch created by the object on the touch device and starting time counting once the touch occurs, keeping detecting and recording time duration of the object staying on the touch device and outputting a control signal representing the touch for being used by the main unit in case of only an effective touch having been detected within the reference time. The touch is determined as an effective touch by way of the object staying on the touch control device exceeding the reference time so that the object is not necessary to be apart from the touch control device immediately with less effort.

### BACKGROUND OF THE INVENTION

1. Field of the Invention

The present invention related to a touch control method and particularly to a method of single tap touch control and a control module thereof.

2. Brief Description of Related Art

The software set up in the current computer mostly presents the window environment thereof by way of Graphical User Interface (GUI) and the advantage of GUI is that a cursor on the screen can be operated by way of auxiliary pointing tool such as a mouse device or trackball moving on a plane. Using GUI is an operation method complying with human's visual sense so that it is a simple way widely utilized by various electronic products with window environment.

In addition to the pointing tools such as the mouse device and the trackball, a similar way such as using a touch pad or a touch panel with screen is also adopted instead. Due to the electronic product being developed with a trend of getting smaller, shorter, lighter and thinner and an approach of the lap top computer being used instead of the table top computer gradually, it allows small sized touch pad or touch panel, which is possible to be associated with the electronic product, to increase applicable extent thereof relatively.

Referring to FIG. 1, the signal processing way of the current touch pad is illustrated. An analog signal being generated after the touch pad 110 being touched is treated with analog/digital conversion by a controller 120 to figure out coordinate values of the touched spot and the gesture of the user is identified as single tap (or single click), double taps (or double clicks), drag or movement. Then, a control signal corresponding to the gesture is transmitted to a main unit 130 so as to control a cursor on the screen of the main unit 130 to perform an action of moving, clicking an object or executing a program.

Referring to FIG. 2, U.S. Pat. No. 6,380,931 disclosed a touch control method for identifying signal tap gesture and the single tap gesture is determined by way of a touch signal 901 generated by a finger hitting the touch pad in very short time t1 before a control signal 902 with a pulse time t2 can be output to reach an action of clicking an object or executing a program. That is, it is necessary for the user to touch the finger on the touch pad and then detach the finger from the touch pad in the short time t1. However, there are following disadvantages while the touch control method is performed:
(1) It needs great effort in case of executing a simple function; and
(2) It is easy to create temporary noise, which is unable to be resisted due to pseudo press phenomenon so that it results in determination mistake.

### SUMMARY OF THE INVENTION

The crux of the present invention is to provide a touch control method of single tap and a control module thereof with which it is not necessary for a finger or another object to be put down on the touch pad and then raised up within short time with great effort so as to avoid determination mistake.

The touch control method of single tap according to the present invention is to identify a touch of an object on a touch control device by way of a control module of the touch device and a control signal being generated corresponding to the touch for being used by a main unit to perform subsequent control functions with reference time being set up in the control module.

The touch control method of single tap includes detecting a touch created by the object on the touch control device and starting time counting once the touch occurs, keeping detecting and recording time duration of the object staying on the touch device and outputting a control signal representing the touch for being used by the main unit in case of only an effective touch having been detected within the reference time. The touch is determined as an effective touch by way of the object staying on the touch control device exceeding the reference time so that the object is not necessary to be apart from the touch control device immediately with less effort.

The control module of the present invention is used to identify a touch of an object on a touch device and a control signal is generated corresponding to the touch for being used by a main unit to perform subsequent control functions. The control module includes an operation unit and a gesture unit connecting to the operation unit and the main unit.

The operation unit generates a corresponding touch signal every time the object touching the touch control device being detected and each generated touch signal starting at the moment of the object touching the touch control device and terminating at the moment of the object leaving the touch control device. The gesture unit connects with the operation unit for receiving the touch signal and figuring out time duration of the object touching the touch control device to identify what action the object does and defining a reference time;

The gesture unit detects a touch created by the object on the touch device and starting time counting once the touch occurs, keeping detecting and recording time duration of the object staying on the touch device and outputting a control signal representing the touch for being used by the main unit in case of only an effective touch having been detected within the reference time.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram illustrating a conventional touch control device being contacted by a finger at the touch control pad and a corresponding control signal is generated and sent to the main unit for further use;

FIG. 2 is a wave curve illustrating touch signal generated during the conventional touch control device being contacted and the corresponding control signal;

FIG. 3 is a block diagram illustrating a preferred embodiment of a control module according to the present invention being disposed between and connected to the touch control device and the main unit;

FIG. 4 is a flow chart illustrating steps of touch control method for single tap; and

FIG. 5 is wave curve illustrating touch signal generated during the touch control device of the present invention in the preferred embodiment thereof being contacted and the corresponding control signal.

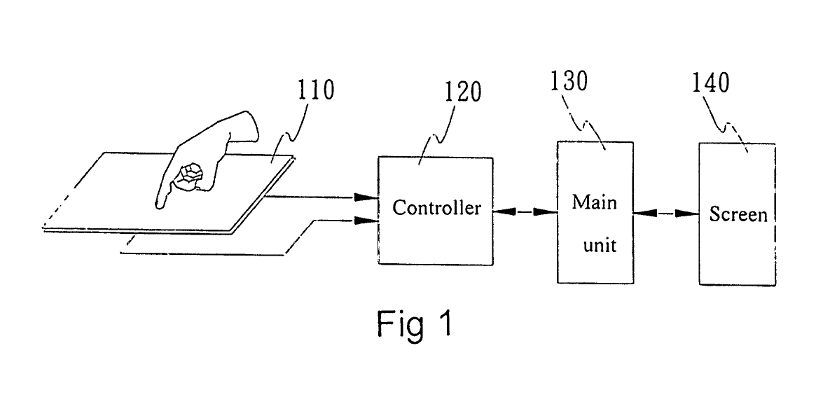

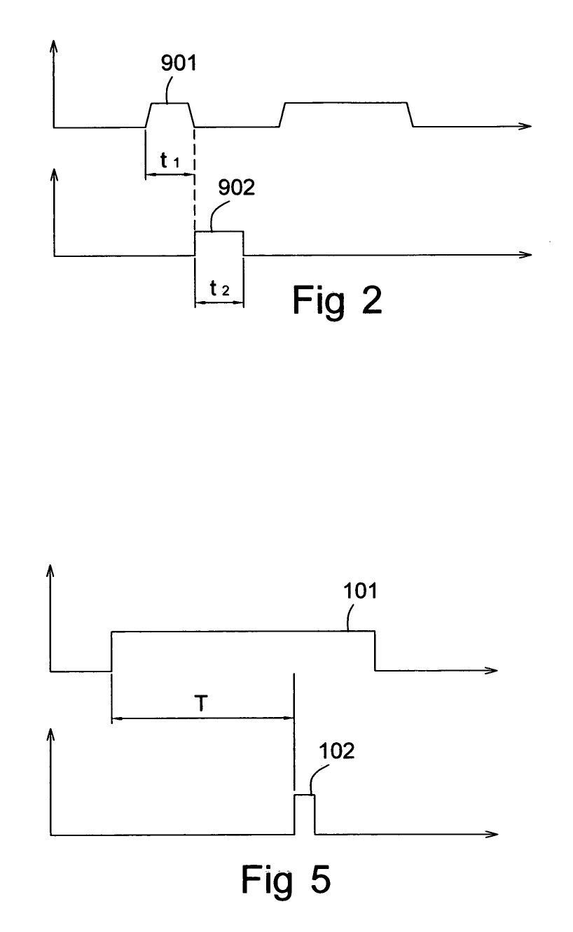

### DETAILED DESCRIPTION OF THE PREFERRED EMBODIMENT

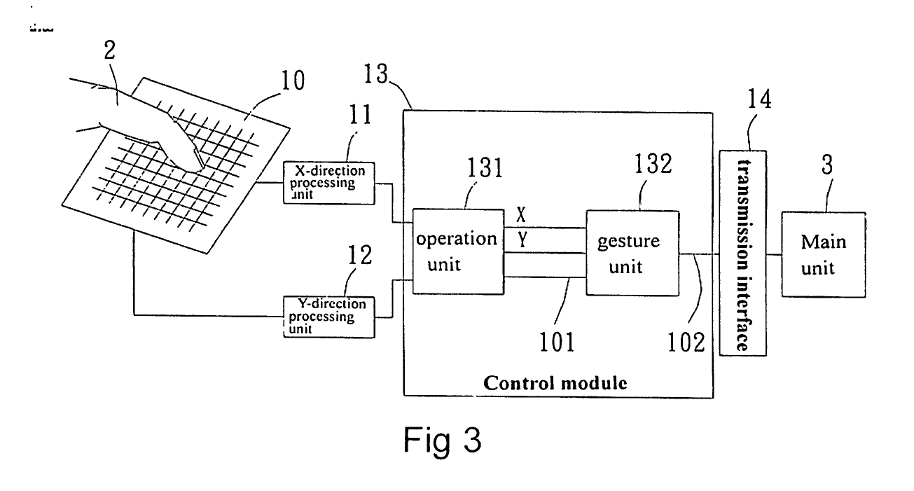

Referring to FIG. 3, a preferred embodiment of a control module according to the present invention is illustrated. The control module 13 is set up between and connected to a touch device 10 and a main unit. The main function of the control module 13 is to receive X, Y coordinate positional parameters (no pressure change and outputs button key signal if the position is default position of client) of the finger 2 or another object on the touch control device 10 detected by a X direction processing unit 11 and Y direction processing unit 12 and converts the coordinate positional parameters into corresponding control signal 102 for being used by the main unit 3 via the transmission interface 14. As for the main unit, it can be an ordinary personal computer, a notebook computer or a portable electronic product.

The control module 13 includes an operation unit 131 and a gesture unit 132 connecting with the operation unit 131 and the main unit 3. The operation unit 131 generates a corresponding touch signal 101 every time the finger 2 or another object touching the touch control device 10 being detected and each generated touch signal 101 lasts a time duration starting at the moment of the finger 2 or another object touching the touch control device 10 and terminating at the moment of the finger 2 or another object leaving the touch control device 10.

The gesture unit 132 is used for receiving the touch signal 101 and figuring out time duration of the finger 2 or another object touching the touch control device 10 and accumulation displacement to identify what action the finger 2 or another object does. A reference time T is also defined in the gesture unit 132.

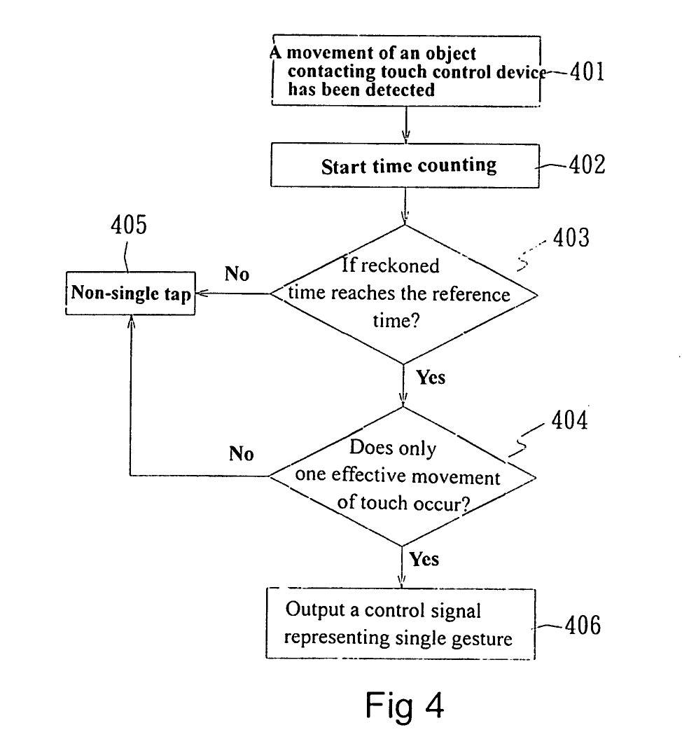

Referring to FIGS. 4 and 5, the touch control method of single tap according to the present invention, as shown in steps 401, 402, the gesture unit 132 can detect and start time counting and keeps detecting and recording time of the finger or another object staying on the touch control device 10 while the action of the finger or another object touching the touch control device 10 occurs. The positive margin, which is temporary state changing from lower lever to high lever, in the wave curve of the touch signal 101 shown in FIG. 5 means the touch action occurring.

When the action of the finger or another object touching the touch control device 10 lasts a time duration exceeding reference time T shown in step 403, that is, when the gesture unit 132 stops reckoning by time in case of accumulation time reaching reference time T, it can be determined the action is single tap gesture in case of the gesture unit 132 having detected only one effective action occurring within the reference time T as shown in step 404, otherwise, it is determined the action is non-single tap gesture and an identification of the non-single tap gesture is processed as shown in step 405.

If step 403, which is the action of the finger or another object touching the touch control device 10 lasting a time duration exceeding reference time T, and step 404, which is only one effective action occurring within the reference time T, are satisfied, step 406 is executed subsequently to output control signal 102 representing the single tap gesture. The control signal 102 outputs to the main unit 3 after time duration from occurring the single tap gesture till reference time T being lapsed, that is, the control signal 102 is sent to the main unit 3 as long as time duration of the finger or another object staying on the touch control device 10 exceeding the reference time T.

The preceding description is summarized in that the touch control method of the single tap according to the present invention is to determine the action being effective in case of the finger or another object staying on the touch control device exceeding the reference time T. After that, the finger or another object has to detach the touch control device immediately. Hence, it is less effort and it is possible to resist temporary noise effectively resulting from pseudo press phenomenon. Therefore, it is not easy to result in determination mistake and it makes the touch control device more flexible and convenient while in use.

While the invention has been described with referencing to the preferred embodiments thereof, it is to be understood that modifications or variations may be easily made without departing from the spirit of this invention, which is defined by the appended claims.

What is claimed is:

1. A touch control method of single tap, which identifies a touch of an object on a touch device by way of a control module of the touch device and a control signal being generated corresponding to the touch for being used by a main unit to perform subsequent control functions with reference time being set up in the control module, comprising the following steps:
A) detecting a touch created by the object on the touch device and starting time counting once the touch occurs;
B) keeping detecting and recording time duration of the object staying on the touch device; and
C) outputting a control signal representing the touch for being used by the main unit in case of only an effective touch having been detected within the reference time.

2. The touch control method as defined in claim 1, wherein the control signal is output to the main unit after the touch occurring and the reference time lapsing.

3. A control module, which identifies a touch of an object on a touch device by way of a control module of the touch device and a control signal being generated corresponding to the touch for being used by a main unit to perform subsequent control functions, comprising:
an operation unit, generating a corresponding touch signal every time the object touching the touch control device being detected and each generated touch signal starting at the moment of the object touching the touch control device and terminating at the moment of the object leaving the touch control device; and
a gesture unit, connecting with the operation unit for receiving the touch signal and figuring out time duration of the object touching the touch control device to identify what action the object does and defining a reference time;
wherein, the gesture unit detecting a touch created by the object on the touch device and starting time counting once the touch occurs, keeping detecting and recording time duration of the object staying on the touch device and outputting a control signal representing the touch for being used by the main unit in case of only an effective touch having been detected within the reference time.

4. The control module as defined in claim 3, wherein the control signal is output to the main unit after the touch occurring and the reference time lapsing.
